(19) United States
(12) Patent Application Publication
(10) Pub. No.: US 2014/0156736 A1
(43) Pub. Date: Jun. 5, 2014

(54) APPARATUS AND METHOD FOR MANAGING THREADS TO PERFORM DIVIDED EXECUTION OF SOFTWARE

(71) Applicant: ELECTRONICS AND TELECOMMUNICATIONS RESEARCH INSTITUTE, Daejeon-city (KR)

(72) Inventors: Moon-Young CHUNG, Daejeon (KR); Won-Young KIM, Daejeon (KR); Su-Min JANG, Daejeon (KR); Won-Hyuk CHOI, Daejeon (KR)

(73) Assignee: ELECTRONICS AND TELECOMMUNICATIONS RESEARCH INSTITUTE, Daejeon-City (KR)

(21) Appl. No.: 14/047,457

(22) Filed: Oct. 7, 2013

(30) Foreign Application Priority Data
Nov. 30, 2012 (KR) 10-2012-0138409

(51) Int. Cl. H04L 29/06

(52) U.S. Cl. CPC H04L 67/42
USPC 709/203

(57) ABSTRACT

Disclosed herein are an apparatus and method for managing threads to perform the divided execution of software. The apparatus includes a server-side thread management apparatus and a client-side thread management apparatus. The server-side thread management apparatus includes a server execution unit, a server device management unit, and a server connection management unit. The server execution unit executes software to be executed in a divided manner, and generates and manages one or more threads for processing one or more of graphics and sound processing functions of the executed software. The server device management unit extracts one or more of a function related to a graphics task and a function related to a sound task from the software. The server connection management unit sends the one or more functions, extracted by the server device management unit, to a client-side thread management apparatus via the threads generated by the server execution unit.

### CROSS REFERENCE TO RELATED APPLICATION

This application claims the benefit of Korean Patent Application No. 10-2012-0138409, filed on Nov. 30, 2012, which is hereby incorporated by reference in its entirety into this application.

### BACKGROUND OF THE INVENTION

1. Technical Field

The present invention relates generally to an apparatus and method for managing threads to perform the divided execution of software and, more particularly, to an apparatus and method for managing threads to perform the divided execution of software, which are capable of managing threads in a process in which a server provides a client with the results of the execution of software and the client renders a software execution result screen, in server-based software service.

2. Description of the Related Art

With the recent development of technology for manufacturing hardware, such as a central processing unit (CPU) and memory, inexpensive and high-performance personal computers (PCs) are increasingly widespread, and the computing capability of PCs has improved to an initial supercomputer level.

As the performance of PCs is improving, software used in PCs is increasingly required to accommodate complicated user interfaces and graphic-intensive tasks.

Furthermore, graphics hardware technology is applied to existing graphic-intensive tasks, such as two-dimensional (2D)/three-dimensional (3D) processing and multimedia, and also extends to and is applied to web browser rendering, flash, and Windows Operating Systems (OSs).

In order to solve various problems relating to data security and a personal computer (PC) management cost in a PC-based computing environment, server-based software service (i.e., a server-based computing environment) is employed. Technologies for supporting server-based software service include XenDesktop by Citrix, VDI by VMWare, and a terminal service based on a Remote Desktop Protocol (RDP) by Microsoft. In connection with this, Korean Patent Application Publication No. 10-2010-0062800 (entitled “Apparatus and Method for 3D Streaming based on Remote Shading”; hereinafter called the conventional art) discloses technology that sends 3D scenes and related data from a server to a remote client in order to provide 3D and virtual reality content, and displays the 3D scenes and the related data on the client. In the conventional art, in order to provide 3D and virtual reality content, a vertex shader and a pixel shader that require 3D acceleration are executed on the server, 3D scenes and related data generated by the execution of the vertex shader and the pixel shader are transmitted to the client, and 3D streaming is implemented via a 2D rasterizer on the client.

The conventional server-based software service is problematic in that a load exerted on a server increases in proportion to an increase in the number of clients because the server executes software and a client PC simply functions as a terminal as described above.

Furthermore, in the conventional server-based software service, high-performance graphics tasks, such as 3D rendering, are limited because result images obtained by the execution results of the server are transmitted to the client. Accordingly, the conventional server-based software service has problems, such as the waste of the resources of an advanced client PC, limited service attributable to a server load, a high server purchasing cost, and low-speed service performance.

Furthermore, in the conventional server-based software service, one server supports a plurality of users via virtual machines in Operating System (OS)-dependent session management technology or desktop service. This results in the problems that the cost required to introduce a server in order to provide server-based software service increases and the management of the server is also limited, because of the dependency of the sever on an OS or the load exerted on the virtual machines.

### SUMMARY OF THE INVENTION

Accordingly, the present invention has been made keeping in mind the above problems occurring in the prior art, and an object of the present invention is to provide an apparatus and method for managing threads to perform the divided execution of software, in which a server provides a client with the results of the execution of software and the client performs graphics rendering using the received execution results. That is, the present invention provides an apparatus and method for managing threads to perform the divided execution of software, in which a server provides a client with the results of the execution of software and the client renders a result screen, rather than the server rendering the result screen, in divided execution technology for server-based software service.

Another object of the present invention is to provide an apparatus and method for managing threads to perform the divided execution of software, which are capable of reducing a load exerted on a server and providing security for user data processed and managed on a server using a method of performing the divided executing of software, in which the client executes graphics-intensive tasks, such as 3D rendering, and server processes data-intensive tasks.

In particular, an object of the present invention is to provide an apparatus and method for managing threads to perform the divided execution of software, in which threads between a server and a client are managed in order to minimize both delay attributable to network transmission and a problem that may occur because of the simultaneous execution of threads when the server sends a divided execution task to the client and receives a result value from the client again so that the client renders a result screen.

In accordance with an aspect of the present invention, there is provided a server-side thread management apparatus, including a server execution unit configured to execute software to be executed in a divided manner, and to generate and manage one or more threads for processing one or more of graphics and sound processing functions of the executed software; a server device management unit configured to extract one or more of a function related to a graphics task and a function related to a sound task from the software; and a server connection management unit configured to send the one or more functions, extracted by the server device management unit, to a client-side thread management apparatus via the threads generated by the server execution unit.

The server execution unit may generate a data storage thread and a data operation thread that process functions corresponding to data-intensive processing of the executed software.

The server execution unit may generate the one or more threads for processing one or more of the function related to the graphics task and the function related to the sound task that have been extracted by the server device management unit; request the client-side thread management apparatus to generate threads corresponding to the generated one or more threads; and generate a plurality of threads for processing client input received from the client-side thread management apparatus.

The server device management unit may include a graphics task extraction module configured to extract the function related to the graphics task from the executed software, and to send the extracted function related to the graphics task to the server connection management unit; a sound task extraction module configured to extract the function related to the sound task from the executed software, and to send the extracted function related to the sound task to the server connection management unit; and a client input processing module configured to process client input received from the server connection management unit.

The server connection management unit may include a graphics task transmission module configured to send the function related to the graphics task, received from the server device management unit, to the client-side thread management apparatus via the thread generated from the server execution unit; a sound task transmission module configured to send the function related to the sound task, received from the server device management unit, to the client-side thread management apparatus via the thread generated from the server execution unit; and a client input reception module configured to receive client input from the client-side thread management apparatus via the thread generated from the server execution unit, and to send the received client input to the server device management unit.

In accordance with an aspect of the present invention, there is provided a client-side thread management apparatus, including a client execution unit configured to request a server-side thread management apparatus to execute software, to generate one or more threads corresponding to one or more threads executed by the server-side thread management apparatus in response to a request from the server-side thread management apparatus, and to manage the generated one or more threads; a client connection management unit configured to receive one or more of a function related to a graphics task and a function related to a sound task from the server-side thread management apparatus via the generated threads; and a client device management unit configured to process the one or more functions, received from the client connection management unit, via the one or more threads generated by the client execution unit.

The client execution unit may generate threads for processing client input, and request the server-side thread management apparatus to generate one or more threads corresponding to the generated threads.

The client device management unit may receive the client input and send the received client input to the client connection management unit, and the client connection management unit may send the received client input to the server-side thread management apparatus via the generated threads.

The client connection management unit may include a graphics task reception module configured to send the function related to the graphics task, received from the server-side thread management apparatus, to the client device management unit via the threads generated by the client execution unit; a sound task reception module configured to send the function related to the sound task, received from the server-side thread management apparatus, to the client device management unit via the threads generated by the client execution unit; and a client input transmission module configured to send client input, received from the client device management unit, to the server-side thread management apparatus via the generated threads.

The client device management unit may include a graphics task processing module configured to process the function related to the graphics task received from the client connection management unit; a sound task processing module configured to process the function related to the sound task received from the client connection management unit; and a client input extraction module configured to extract client input, and to send the extracted client input to the client connection management unit.

In accordance with still another aspect of the present invention, there is provided a method of managing threads to perform divided execution of software, including executing, by a server-side thread management apparatus, software in response to a software execution request received from a client-side thread management apparatus; extracting, by the server-side thread management apparatus, one or more of a function related to a graphics task and a function related to a sound task from the executed software, and sending, by the server-side thread management apparatus, the extracted one or more functions to the client-side thread management apparatus via one or more threads; and receiving, by the client-side thread management apparatus, the one or more functions via threads, and processing, by the client-side thread management apparatus, the received one or more functions.

Extracting the one or more of the function related to the graphics task and the function related to the sound task and sending the extracted one or more functions may include generating, by the server-side thread management apparatus, the one or more threads for processing one or more of the function related to the graphics task and the function related to the sound task, and executing, by the server-side thread management apparatus, the generated one or more threads; requesting, by the server-side thread management apparatus, the client-side thread management apparatus to generate threads corresponding to the executed threads; extracting, by the server-side thread management apparatus, one or more of the function related to the graphics task and the function related to the sound task from the executed software; storing, by the server-side thread management apparatus, the extracted one or more functions; and detecting, by the server-side thread management apparatus, the stored one or more functions and, by the server-side thread management apparatus, processing the detected one or more functions.

Storing the extracted one or more functions may include storing, by the server-side thread management apparatus, the extracted one or more functions in a synchronous/asynchronous buffer when the extracted function is a void function.

Detecting the stored one or more functions and processing the detected one or more functions may include detecting, by the server-side thread management apparatus, functions stored in a synchronous/asynchronous buffer when the synchronous/asynchronous buffer for storing the functions is in a full state; and sending, by the server-side thread management apparatus, the detected functions to the client-side thread management apparatus.

Detecting the stored one or more functions and processing the detected one or more functions may include sending, by the server-side thread management apparatus, the extracted one or more functions and functions stored in a synchronous/asynchronous buffer to the client-side thread management apparatus when the extracted functions are not void functions.

Detecting the stored one or more functions and processing the detected one or more functions may further include receiving, by the server-side thread management apparatus, results of processing of the transmitted functions from the client-side thread management apparatus.

Receiving the one or more functions and processing the received one or more functions may include generating, by the client-side thread management apparatus, a reception-dedicated thread and a function processing thread in response to a thread generation request from the server-side thread management apparatus, and executing, by the client-side thread management apparatus, the reception-dedicated thread and the function processing thread; receiving, by the client-side thread management apparatus, a function via the reception-dedicated thread, and storing, by the client-side thread management apparatus, the received function in an asynchronous buffer; and processing, by the client-side thread management apparatus, a function received via the function processing thread.

Processing the function received via the function processing thread may include checking, by the client-side thread management apparatus, whether the function received via the function processing thread is a function to be executed next; storing, by the client-side thread management apparatus, the received function in a synchronous buffer if the function received via the function processing thread is a function to be executed next; and extracting, by the client-side thread management apparatus, a function to be executed next from the synchronous buffer and the asynchronous buffer.

Processing the function received through the function processing thread may further include processing, by the client-side thread management apparatus, the function determined to be a function to be executed next or the function extracted from the synchronous buffer and the asynchronous buffer.

Processing the function received through the function processing thread further may include sending, by the client-side thread management apparatus, the results of the processed function to the server-side thread management apparatus when the processed function is not a void function.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an apparatus for managing threads to perform the divided execution of software according to an embodiment of the present invention;

FIG. 2 is a diagram illustrating the server-side thread management apparatus of FIG. 1;

FIG. 3 is a diagram illustrating the client-side thread management apparatus of FIG. 1;

FIGS. 4 and 5 are diagrams illustrating the structure and operation of threads for performing the divided execution of software in the apparatus for managing threads to perform the divided execution of software according to an embodiment of the present invention;

FIG. 6 is a flowchart illustrating a method of managing threads to perform the divided execution of software according to an embodiment of the present invention;

FIG. 7 is a flowchart illustrating a server-side thread management step of FIG. 6; and

FIG. 8 is a flowchart illustrating a client-side thread management step of FIG. 6.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

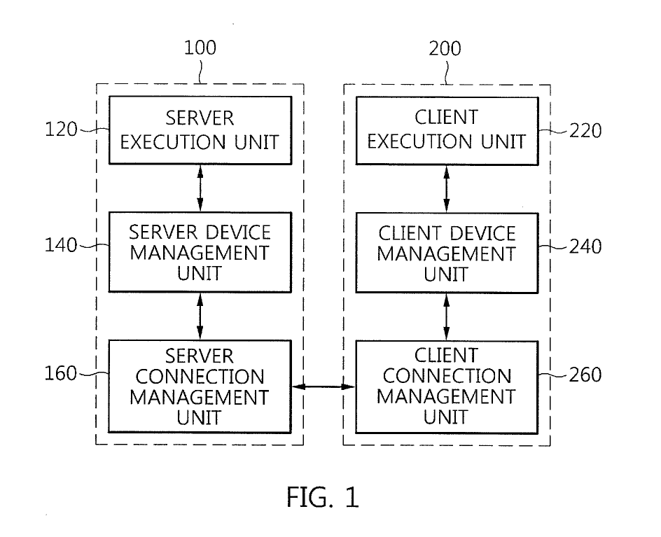

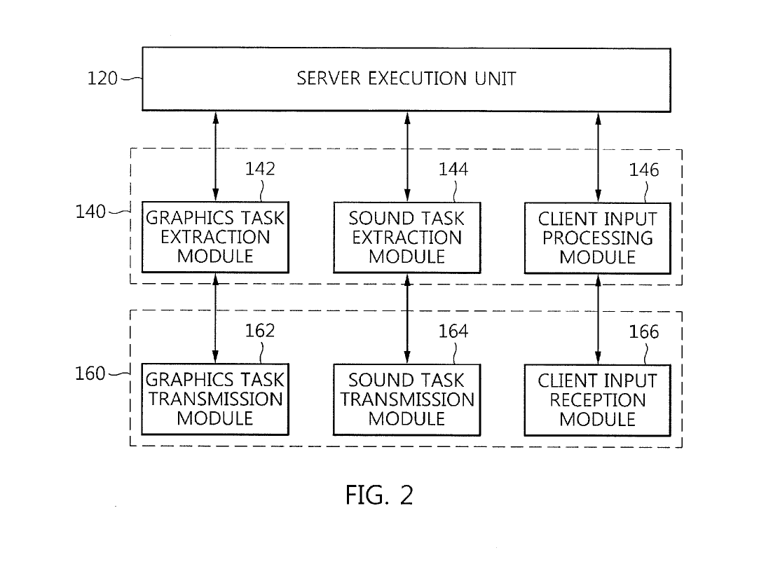

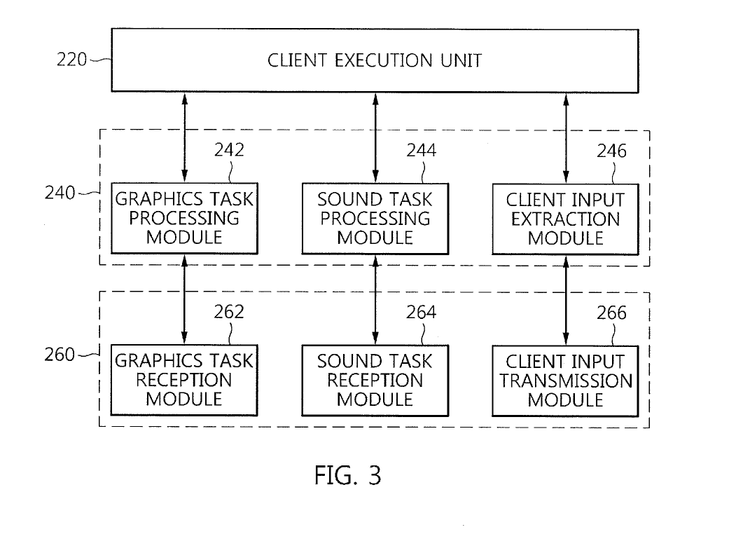

An apparatus for managing threads to perform the divided execution of software according to an embodiment of the present invention will be described in detail below with reference to the accompanying drawings. FIG. 1 is a diagram illustrating the apparatus for managing threads to perform the divided execution of software according to an embodiment of the present invention, FIG. 2 is a diagram illustrating the server-side thread management apparatus of FIG. 1, and FIG. 3 is a diagram illustrating the client-side thread management apparatus of FIG. 1.

As shown in FIG. 1, the apparatus for managing threads to perform the divided execution of software includes a server-side thread management apparatus 100 for executing the data-intensive tasks of software executed by a server-based software service system, and a client-side thread management apparatus 200 for executing the graphics and sound tasks of software. Although in FIG. 1, the server-side thread management apparatus 100 and the client-side thread management apparatus 200 are illustrated as being separate devices for ease of the description of the embodiment of the present invention, the present invention is not limited thereto. For example, the server-side thread management apparatus 100 and the client-side thread management apparatus 200 may be contained in a server and a client, respectively, in the form of modules.

While software is executed by the server, the client-side thread management apparatus 200 displays the execution results of the software and a user interface on the client. Accordingly, the server-side thread management apparatus 100 extracts graphics and sound tasks that should be processed by the client, and sends the graphics and sound tasks to the client-side thread management apparatus 200. The client-side thread management apparatus 200 extracts user input information (i.e., client input) entered through a keyboard or a mouse from the client, and sends the extracted user information to the server-side thread management apparatus 100.

The server-side thread management apparatus 100 is installed on the server side of a server-based software service system, and the server-side thread management apparatus 100 executes the data-intensive tasks of software in response to a request from a client. That is, the server-side thread management apparatus 100 executes software in response to a software execution request from the client-side thread management apparatus 200. Here, the server-side thread management apparatus 100 processes the data-intensive tasks of the software. To perform the divided execution of software, the server-side thread management apparatus 100 sends functions related to the graphics and sound processing of the software to the client-side thread management apparatus 200. Here, the server-side thread management apparatus 100 generates threads in order to process the functions related to graphics and sound processing. The server-side thread management apparatus 100 requests the client-side thread management apparatus 200 to generate a plurality of threads connected to the generated threads. When the threads are generated on the server side and the client side, the server-side thread management apparatus 100 sends the functions related to graphics and sound processing to the client-side thread management apparatus 200. The server-side thread management apparatus 100 receives client input from the client-side thread management apparatus 200 via the generated threads. The server-side thread management apparatus 100 performs data processing corresponding to the received client input. The server-side thread management apparatus 100 sends the results of the executed data processing to the client-side thread management apparatus 200 via the threads.

For this purpose, the server-side thread management apparatus 100 includes a server execution unit 120, a server device management unit 140, and a server connection management unit 160.

The server execution unit 120 executes software in response to a software execution request from the client-side thread management apparatus 200. Here, the server execution unit 120 performs only functions, corresponding to data-intensive processing, which belong to a plurality of functions included in the software. For this purpose, the server execution unit 120 generates a data storage thread for storing user data and a data operation thread for performing operation using the user data stored in the data storage thread.

The server execution unit 120 controls the server connection management unit 160 so that the server connection management unit 160 sends graphics and sound tasks, extracted by the server device management unit 140, to the client-side thread management apparatus 200. That is, when the server device management unit 140 extracts a function related to the graphics task and a function related to the sound task, the server execution unit 120 generates a plurality of threads for sending the function related to the graphics task and the function related to the sound task.

The server execution unit 120 sends a thread generation request to the client-side thread management apparatus 200. Here, the server execution unit 120 sends a thread generation request requesting threads, corresponding to a plurality of respective previously generated threads, to be generated to the client-side thread management apparatus 200. The server execution unit 120 generates one or more threads for processing client input in response to a thread generation request from the client-side thread management apparatus 200.

The server execution unit 120 controls the server device management unit 140 and the server connection management unit 160 so that the graphics task and the sound task extracted by the server device management unit 140 are transmitted to the client-side thread management apparatus 200 via the plurality of previously generated threads.

The server device management unit 140 extracts the function related to the graphics task and the function related to the sound task from the software executed by the server execution unit 120. The server device management unit 140 sends the extracted function related to the graphics task and the extracted function related to the sound task to the server connection management unit 160 under the control of the server execution unit 120. The server device management unit 140 processes the client input received from the client-side thread management apparatus 200.

For this purpose, as shown in FIG. 2, the server device management unit 140 includes a graphics task extraction module 142 for extracting the function related to the graphics task of the software, a sound task extraction module 144 for extracting the function related to the sound task of the software, and a client input processing module 146 for processing the client input received through the server connection management unit 160.

The server connection management unit 160 sends the function related to the graphics task and the function related to the sound task, received from the server device management unit 140, to the client-side thread management apparatus 200 under the control of the server execution unit 120. That is, the server connection management unit 160 receives the function related to the graphics task from the graphics task extraction module 142. The server connection management unit 160 receives the function related to the sound task from the sound task extraction module 144. The server connection management unit 160 sends the function related to the graphics task and the function related to the sound task, which have been previously received, to the client-side thread management apparatus 200 via the threads generated from the server execution unit 120.

The server connection management unit 160 receives the client input from the client-side thread management apparatus 200. The server connection management unit 160 sends the received client input to the server device management unit 140, that is, the client input processing module 146.

For this purpose, as shown in FIG. 2, the server connection management unit 160 includes a graphics task transmission module 162 for sending the function related to the graphics task, received from the graphics task extraction module 142, to the client-side thread management apparatus 200 via a thread, a sound task transmission module 164 for sending the function related to the sound task, received from the sound task extraction module 144, to the client-side thread management apparatus 200 via a thread, and a client input reception module 166 for receiving the client input from the client-side thread management apparatus 200 and sending the received client input to the server device management unit 140, that is, the client input processing module 146.

The client-side thread management apparatus 200 is installed on the client side of the server-based software service system, and the client-side thread management apparatus 200 receives the graphics and sound tasks of software from the server-side thread management apparatus 100 and executes the received graphics and sound tasks. That is, the client-side thread management apparatus 200 receives functions related to graphics and sound processing on which a data-intensive task has been completed by a server from the server-side thread management apparatus 100. The client-side thread management apparatus 200 performs tasks, such as the graphics rendering and sound output of software, by performing the received functions. The client-side thread management apparatus 200 sends client input, received from a user, to the server-side thread management apparatus 100.

For this purpose, the client-side thread management apparatus 200 includes a client execution unit 220, a client device management unit 240, and a client connection management unit 260.

The client execution unit 220 sends a software execution request to the server-side thread management apparatus 100 in response to a request from a user. Here, the client execution unit 220 generates a thread for receiving and processing a function related to the graphics task and a thread for receiving and processing a function related to the sound task in response to a request (i.e., a thread generation request) from the server-side thread management apparatus 100.

The client execution unit 220 generates a thread for processing client input from a user. The client execution unit 220 sends the thread generation request to the server-side thread management apparatus 100. Here, the client execution unit 220 sends a thread generation request, requesting the generation of one or more threads corresponding to previously generated threads, to the server-side thread management apparatus 100.

The client execution unit 220 controls the client device management unit 240 and the client connection management unit 260 so that they process the function related to the graphics task and the function related to the sound task that have been received from the server-side thread management apparatus 100. The client execution unit 220 controls the client device management unit 240 and the client connection management unit 260 so that they extract user input and send the extracted user input to the server-side thread management apparatus 100.

The client device management unit 240 processes the function related to the graphics task and the function related to the sound task under the control of the client execution unit 220. That is, the client device management unit 240 receives the function related to the graphics task and the function related to the sound task from the client connection management unit 260. The client device management unit 240 processes the function related to the graphics task and the function related to the sound task.

The client device management unit 240 extracts client input from the user input. That is, the client device management unit 240 extracts the client input entered through a keyboard and a mouse. The client device management unit 240 sends the extracted client input to the client connection management unit 260.

For this purpose, as shown in FIG. 3, the client device management unit 240 includes a graphics task processing module 242 for processing the function related to the graphics task that has been received from the client connection management unit 260, a sound task processing module 244 for processing the function related to the sound task that has been received from the client connection management unit 260, and a client input extraction module 246 for extracting the client input and sending the extracted client input to the client connection management unit 260.

The client connection management unit 260 sends the client input, received from the client device management unit 240, to the server-side thread management apparatus 100 under the control of the client execution unit 220. That is, the client connection management unit 260 receives the client input from the client input extraction module 246. The client connection management unit 260 sends the client input previously received to the server-side thread management apparatus 100 via a thread generated from the client execution unit 220.

The client connection management unit 260 receives the function related to the graphics task and the function related to the sound task from the server-side thread management apparatus 100. The client connection management unit 260 sends the function related to the graphics task and the function related to the sound task to the client device management unit 240.

For this purpose, as shown in FIG. 3, the client connection management unit 260 includes a graphics task reception module 262 for receiving the function related to the graphics task from the server-side thread management apparatus 100 and sending the function related to the graphics task to the client device management unit 240 (i.e., the graphics task processing module 242), a sound task reception module 264 for receiving the function related to the sound task from the server-side thread management apparatus 100 and sending the function related to the sound task to the client device management unit 240 (i.e., the sound task processing module 244), and a client input transmission module 266 for sending the client input, received from the client device management unit 240 (i.e., the client input extraction module 246), to the server-side thread management apparatus 100.

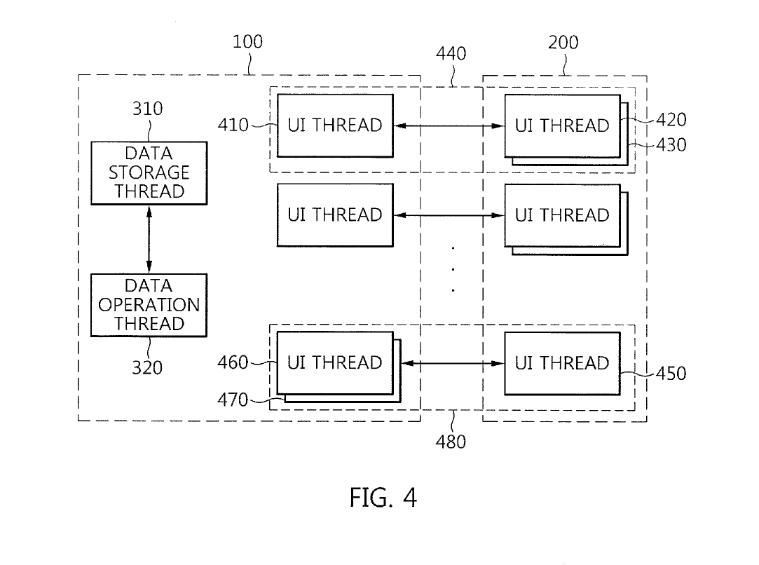

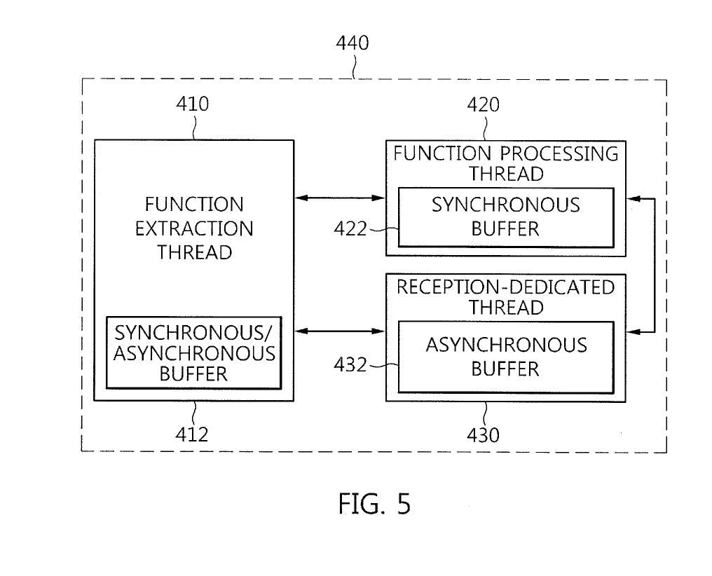

The structure and operation of a thread for the divided execution of software in the apparatus for managing threads to perform the divided execution of software according to an embodiment of the present invention will be described in detail below with reference to FIGS. 4 and 5. FIGS. 4 and 5 are diagrams illustrating the structure and operation of threads for performing the divided execution of software in the apparatus for managing threads to perform the divided execution of software according to an embodiment of the present invention.

FIG. 4 a diagram illustrating a User Interface (UI) thread structure for performing the extraction, transmission, reception, and processing of graphic, sound, and input tasks between the server-side thread management apparatus 100 and the client-side thread management apparatus 200.

In an environment for the divided execution of software, in order to provide security for user data processed and managed by a client, data-intensive tasks are processed by a server. For this purpose, the server-side thread management apparatus 100 generates a data storage thread 310 for storing user data and a data operation thread 320, and manages the data storage thread 310 and the data operation thread 320.

Tasks related to a user UI, including a function related to a graphics task, a function related to a sound task, and the processing of client input, are subject to divided execution in the server-side thread management apparatus 100 and the client-side thread management apparatus 200. Accordingly, the server-side thread management apparatus 100 and the client-side thread management apparatus 200 generate corresponding UI threads 410, 420, and 430 in the form of one thread pool 440, and manage the thread pool 440. Here, the server-side thread management apparatus 100 and the client-side thread management apparatus 200 may generate and manage one or more thread pools 440 in accordance with the type of software to be executed in a divided manner.

The server-side thread management apparatus 100 generates one or more UI threads 410 when a function related to a graphics task and a function related to a sound task are transmitted. The client-side thread management apparatus 200 generates a plurality of the UI threads 420 and 430 corresponding to the UI thread 410 generated from the server-side thread management apparatus 100.

The threads 410, 420, and 430 of the thread pool 440 and the threads of another thread pool include independent connection transmission and reception buffers between the server-side thread management apparatus 100 and the client-side thread management apparatus 200. In this case, problems that may occur due to the simultaneous execution of the threads are minimized. Here, the number of generated thread pools 440 may differ depending on the configuration of software to be executed in a divided manner.

In order to send client input, the client-side thread management apparatus 200 generates one or more UI threads 450 for sending an input function. The server-side thread management apparatus 100 generates a plurality of UI threads 460 and 470 corresponding to the UI thread 450 that is generated by the client-side thread management apparatus 200. The client-side thread management apparatus 200 and the server-side thread management apparatus 100 manage the previously generated UI threads 450, 460, and 470 in the form of one thread pool 480.

FIG. 5 is a detailed diagram showing the UI thread pool of FIG. 4. That is, FIG. 5 is a detailed diagram showing the thread pool 440 that is used when the server-side thread management apparatus 100 extracts a function related to a graphics task or a function related to a sound task, and sends the function to the client-side thread management apparatus 200.

As shown in FIG. 5, the thread pool 440 includes a function extraction thread 410, a function processing thread 420, and a reception-dedicated thread 430.

The function extraction thread 410 extracts a function related to a graphics task and a function related to a sound task from software executed by the server-side thread management apparatus 100, and sends the extracted functions to the client-side thread management apparatus 200. Here, the function extraction thread 410 stores the function related to the graphics task and the function related to the sound task in buffers instead of sending the functions one by one, and sends the stored functions at the same time depending on the type of extracted function. For this purpose, the function extraction thread 410 includes a synchronous/asynchronous buffer 412 for storing the function related to the graphics task and the function related to the sound task. If an extracted function is a void function without a result value (or return value), the function extraction thread 410 sends functions, stored in the synchronous/asynchronous buffer 412, to the reception-dedicated thread 430 at one time after the synchronous/asynchronous buffer 412 have been full of functions. If an extracted function is a function having a result value (i.e., not a void function), the function extraction thread 410 sends the extracted function, together with functions stored in the synchronous/asynchronous buffer 412, to the function processing thread 420 because the function extraction thread 410 can process a subsequent instruction based on the result value after receiving the result value. In this case, delay in the execution of software to be executed in a divided manner, attributable to a network load, can be prevented upon providing divided software execution service.

The function processing thread 420 is synchronized and connected with the function extraction thread 410. The function processing thread 420 may immediately process a function received from the function extraction thread 410 and return a result value to the function extraction thread 410, or may store the received function in a synchronous buffer 422.

The reception-dedicated thread 430 stores a function, received from the function extraction thread 410, in an asynchronous buffer 432. Here, functions stored in the asynchronous buffer 432 are detected and processed by the function processing thread 420 in the appropriate sequence of functions being executed.

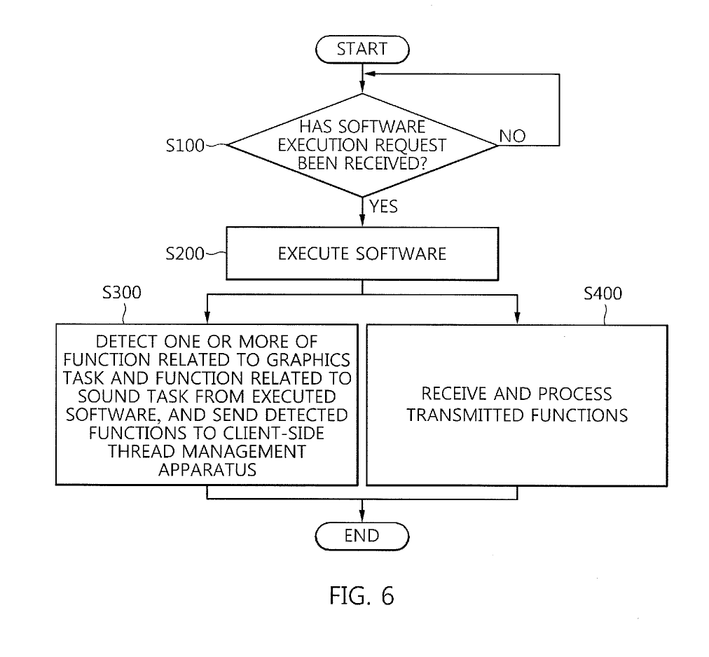

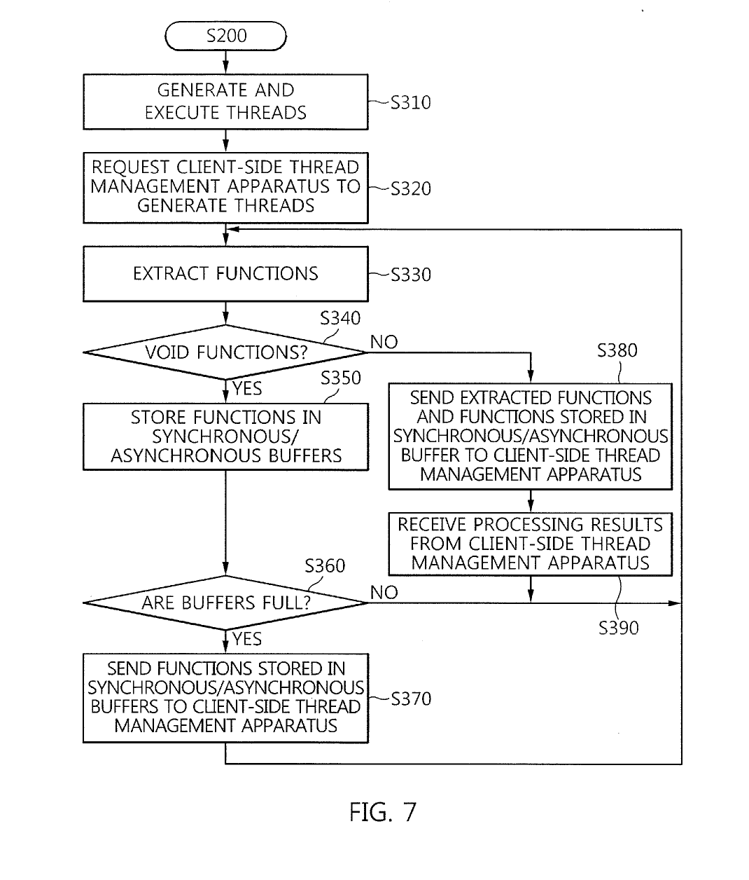

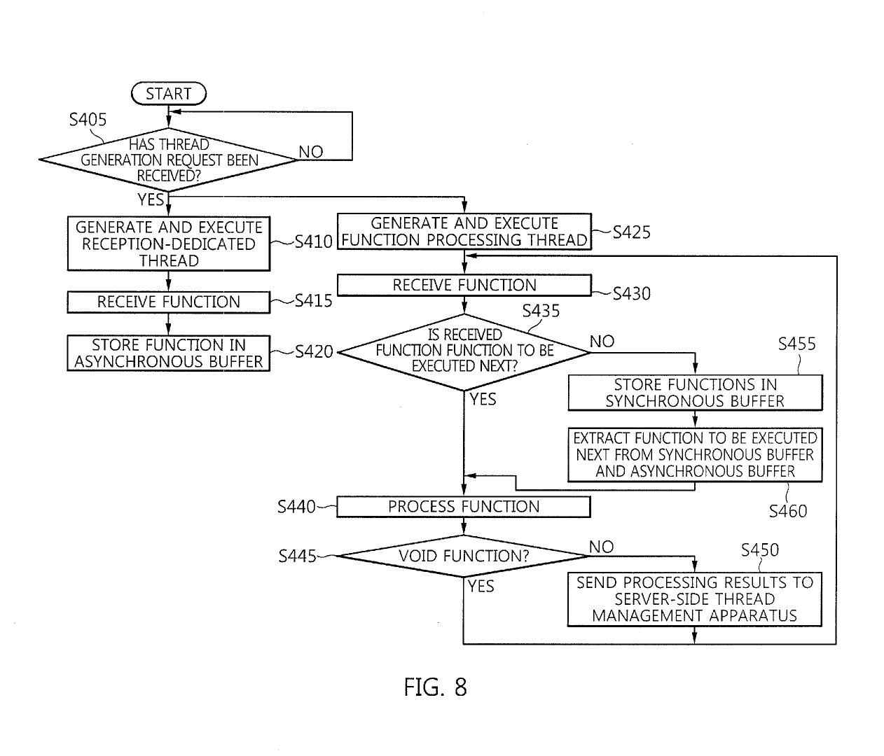

A method of managing threads to perform the divided execution of software according to an embodiment of the present invention will be described in detail below with reference to FIGS. 6 to 8. FIG. 6 is a flowchart illustrating the method of managing threads to perform the divided execution of software according to an embodiment of the present invention, FIG. 7 is a flowchart illustrating a server-side thread management step of FIG. 6, and FIG. 8 is a flowchart illustrating a client-side thread management step of FIG. 6.

First, the client-side thread management apparatus 200 sends an access request to the server-side thread management apparatus 100 in response to a request from a user. The server-side thread management apparatus 100 performs user authentication on the client-side thread management apparatus 200 that has sent the access request. If the user authentication is successful, the server-side thread management apparatus 100 sends an authentication success message to the client-side thread management apparatus 200. The client-side thread management apparatus 200 sends a software execution request to the server-side thread management apparatus 100 in response to a software execution request from the user who has been successfully authenticated. In response to the software execution request from the client-side thread management apparatus 200 (YES at step S100), the server-side thread management apparatus 100 executes software corresponding to the software execution request at step S200.

The server-side thread management apparatus 100 performs a server-side thread management step while operating in conjunction with the client-side thread management apparatus 200 at step S300. That is, the server-side thread management apparatus 100 generates threads for performing the divided execution of software along with the client-side thread management apparatus 200. The server-side thread management apparatus 100 internally processes functions related to the data-intensive tasks of the executed software. The server-side thread management apparatus 100 extracts a function related to a graphics task and a function related to a sound task from the executed software, and sends the extracted functions to the client-side thread management apparatus 200 via the previously generated threads. The server-side thread management step will be described in greater detail below with reference to FIG. 7.

The server-side thread management apparatus 100 generates the threads for performing the divided execution of software and executes the generated threads at step S310. Here, the server-side thread management apparatus 100 generates the data storage thread 310 and the data operation thread 320 for processing the data-intensive tasks of the software, and executes the data storage thread 310 and the data operation thread 320. The server-side thread management apparatus 100 generates one or more threads for processing the function related to the graphics task and the function related to the sound task. Here, the server-side thread management apparatus 100 generates the function extraction thread 410 for extracting the function related to the graphics task and the function related to the sound task from the software being executed, and executes the generated function extraction thread 410.

The server-side thread management apparatus 100 requests the client-side thread management apparatus 200 to generate threads at step S320. Here, the server-side thread management apparatus 100 requests the client-side thread management apparatus 200 to generate a plurality of threads (e.g., the function processing thread 420 and the reception-dedicated thread 430) corresponding to the previously generated function extraction thread 410.

When the threads are executed by the client-side thread management apparatus 200, the server-side thread management apparatus 100 extracts the function related to the graphics task and the function related to the sound task from the software being executed at step S330. The extraction of the functions is performed by the previously generated function extraction thread 410.

The server-side thread management apparatus 100 checks whether each of the extracted functions is a void function at step S340. That is, the server-side thread management apparatus 100 checks whether the function related to the graphics task or the function related to the sound task that has been extracted by the function extraction thread 410 is a void function without a result value (i.e., a return value). If the extracted function is a void function (YES at step S340), the server-side thread management apparatus 100 stores the extracted function in a synchronous/asynchronous buffer at step S350. The synchronous/asynchronous buffer is the synchronous/asynchronous buffer 412 of the function extraction thread 410.

The server-side thread management apparatus 100 checks whether the synchronous/asynchronous buffer for storing functions is in a full state. If the synchronous/asynchronous buffer is in a full state (YES at step S360), the server-side thread management apparatus 100 sends functions, stored in the synchronous/asynchronous buffer, to the client-side thread management apparatus 200 at step S370. If the synchronous/asynchronous buffer is not in a full state (NO at step S360), the server-side thread management apparatus 100 extracts a subsequent function.

If, as a result of the checking at step S340, the extracted function is not a void function (NO at step S340), the server-side thread management apparatus 100 sends the extracted function to the client-side thread management apparatus 200. Here, the server-side thread management apparatus 100 sends a function stored in the synchronous/asynchronous buffer, together with the extracted function, to the client-side thread management apparatus 200 at step S380.

The server-side thread management apparatus 100 receives the processing results of previously transmitted functions from the client-side thread management apparatus 200 at step S390. Thereafter, the server-side thread management apparatus 100 extracts a subsequent function.

Furthermore, the client-side thread management apparatus 200 performs a client-side thread management step while operating in conjunction with the server-side thread management apparatus 100 at step S400. The client-side thread management step will be described in greater detail below with reference to FIG. 8.

When a thread generation request is received from the server-side thread management apparatus 100 (YES at step S405), the client-side thread management apparatus 200 generates the reception-dedicated thread 430 and executes the generated reception-dedicated thread 430 at step S410.

The client-side thread management apparatus 200 receives a function via the previously generated reception-dedicated thread 430 at step S415 and stores the received function in the asynchronous buffer 432 of the reception-dedicated thread 430 at step S420.

The client-side thread management apparatus 200 generates the function processing thread 420 and executes the generated function processing thread 420 along with the reception-dedicated thread 430 at step S425.

The client-side thread management apparatus 200 receives a function via the previously generated function processing thread 420 at step S430, and checks whether the received function is a function to be executed next. If the received function is a function to be executed next (YES at step S435), the client-side thread management apparatus 200 processes the received function at step S440. That is, the client-side thread management apparatus 200 performs rendering using a function related to a graphics task that has been received from the function processing thread 420, and outputs the results of the rendering to a screen. Furthermore, the client-side thread management apparatus 200 performs a function related to a sound task that has been received from the function processing thread 420, and outputs sound as the results of the processing.

After the function has been processed, the client-side thread management apparatus 200 checks whether the processed function is a void function. If the processed function is a void function (YES at step S445), the client-side thread management apparatus 200 receives a subsequent function. If the processed function is not a void function (NO at step S445), the client-side thread management apparatus 200 sends the results of the processed function to the server-side thread management apparatus 100 at step S450.

If the received function is not a function to be executed next (NO at step S435), the client-side thread management apparatus 200 stores the received function in the synchronous buffer 422 at step S455.

The client-side thread management apparatus 200 checks functions stored in the synchronous buffer 422 and the asynchronous buffer 432 and extracts a function to be executed next from the stored functions at step S460. Thereafter, the client-side thread management apparatus 200 processes the extracted function. If the function is not a void function, the client-side thread management apparatus 200 sends the results of the processing to the server-side thread management apparatus 100.

FIGS. 6 and 7 illustrate a process in which the server-side thread management apparatus 100 sends a function related to a graphics task and a function related to a sound task to the client-side thread management apparatus 200 and the client-side thread management apparatus 200 processes the function related to the graphics task and the function related to the sound task. A process in which the client-side thread management apparatus 200 sends a client input, such as input entered through a keyboard or a mouse, to the server-side thread management apparatus 100 and the server-side thread management apparatus 100 processes the received client input can be sufficiently implemented by the above-described method, and thus a detailed description thereof is omitted.

As described above, in accordance with the present invention, the apparatus and method for managing threads for the divided execution of software is advantageous in that they can minimize the load exerted on the CPU of the server due to graphics and sound processing because the server provides the client with the results of the execution of software and the client performs graphics rendering using the received results.

Furthermore, the apparatus and method for managing threads for the divided execution of software are advantageous in that they can implement the same performance as when several additional servers are installed because the utilization of the CPU of the server can increase, reduce the cost attributable to virtualization, and minimize a software licensing cost by minimizing the load exerted on the CPU of the server because of graphics and sound processing.

Furthermore, in order for the client to render a result screen, the server should send a divided execution command to the client, and receive a result value from the client in accordance with a function. In contrast, in the apparatus and method for managing threads to perform the divided execution of software, a function is extracted from a server and a client in accordance with the type of software to be executed in a divided manner, the extracted function is transmitted, one or more thread pools that are received and processed are generated, and the threads of one thread pool have independent connections and transmission and reception buffers between the server and the client. Accordingly, there are advantages in that problems that may occur because of the simultaneous execution of threads can be minimized and delay attributable to a network transmission load can be minimized.

Furthermore, in the apparatus and method for managing threads for the divided execution of software, the client receives functions, classifies the received functions into the function processing thread and the reception-dedicated thread depending on whether the received function is a function whose result value should be returned or a void function without a result value, and processes the classified functions, and threads have different buffers. Accordingly, there is an advantage in that delay attributable to transmission can be minimized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A server-side thread management apparatus, comprising:
a server execution unit configured to execute software to be executed in a divided manner, and to generate and manage one or more threads for processing one or more of graphics and sound processing functions of the executed software;
a server device management unit configured to extract one or more of a function related to a graphics task and a function related to a sound task from the software; and
a server connection management unit configured to send the one or more functions, extracted by the server device management unit, to a client-side thread management apparatus via the threads generated by the server execution unit.

2. The server-side thread management apparatus of claim 1, wherein the server execution unit generates a data storage thread and a data operation thread that process functions corresponding to data-intensive processing of the executed software.

3. The server-side thread management apparatus of claim 1, wherein the server execution unit:
generates the one or more threads for processing one or more of the function related to the graphics task and the function related to the sound task that have been extracted by the server device management unit;
requests the client-side thread management apparatus to generate threads corresponding to the generated one or more threads; and
generates a plurality of threads for processing client input received from the client-side thread management apparatus.

4. The server-side thread management apparatus of claim 1, wherein the server device management unit includes:
a graphics task extraction module configured to extract the function related to the graphics task from the executed software, and to send the extracted function related to the graphics task to the server connection management unit;
a sound task extraction module configured to extract the function related to the sound task from the executed software, and to send the extracted function related to the sound task to the server connection management unit; and
a client input processing module configured to process client input received from the server connection management unit.

5. The server-side thread management apparatus of claim 1, wherein the server connection management unit includes:
a graphics task transmission module configured to send the function related to the graphics task, received from the server device management unit, to the client-side thread management apparatus via the thread generated from the server execution unit;
a sound task transmission module configured to send the function related to the sound task, received from the server device management unit, to the client-side thread management apparatus via the thread generated from the server execution unit; and
a client input reception module configured to receive client input from the client-side thread management apparatus via the thread generated from the server execution unit, and to send the received client input to the server device management unit.

6. A client-side thread management apparatus, comprising:
a client execution unit configured to request a server-side thread management apparatus to execute software, to generate one or more threads corresponding to one or more threads executed by the server-side thread management apparatus in response to a request from the server-side thread management apparatus, and to manage the generated one or more threads;
a client connection management unit configured to receive one or more of a function related to a graphics task and a function related to a sound task from the server-side thread management apparatus via the generated threads; and
a client device management unit configured to process the one or more functions, received from the client connection management unit, via the one or more threads generated by the client execution unit.

7. The client-side thread management apparatus of claim 6, wherein the client execution unit generates threads for processing client input, and requests the server-side thread management apparatus to generate one or more threads corresponding to the generated threads.

8. The client-side thread management apparatus of claim 7, wherein:
the client device management unit receives the client input, and sends the received client input to the client connection management unit; and
the client connection management unit sends the received client input to the server-side thread management apparatus via the generated threads.

9. The client-side thread management apparatus of claim 6, wherein the client connection management unit includes:
a graphics task reception module configured to send the function related to the graphics task, received from the server-side thread management apparatus, to the client device management unit via the threads generated by the client execution unit;
a sound task reception module configured to send the function related to the sound task, received from the server-side thread management apparatus, to the client device management unit via the threads generated by the client execution unit; and
a client input transmission module configured to send client input, received from the client device management unit, to the server-side thread management apparatus via the generated threads.

10. The client-side thread management apparatus of claim 6, wherein the client device management unit includes:
a graphics task processing module configured to process the function related to the graphics task received from the client connection management unit;
a sound task processing module configured to process the function related to the sound task received from the client connection management unit; and
a client input extraction module configured to extract client input, and to send the extracted client input to the client connection management unit.

11. A method of managing threads to perform divided execution of software, comprising:
executing, by a server-side thread management apparatus, software in response to a software execution request received from a client-side thread management apparatus;
extracting, by the server-side thread management apparatus, one or more of a function related to a graphics task and a function related to a sound task from the executed software, and sending, by the server-side thread management apparatus, the extracted one or more functions to the client-side thread management apparatus via one or more threads; and
receiving, by the client-side thread management apparatus, the one or more functions via threads, and processing, by the client-side thread management apparatus, the received one or more functions.

12. The thread management method of claim 11, wherein extracting the one or more of the function related to the graphics task and the function related to the sound task and sending the extracted one or more functions includes:
generating, by the server-side thread management apparatus, the one or more threads for processing one or more of the function related to the graphics task and the function related to the sound task, and executing, by the server-side thread management apparatus, the generated one or more threads;
requesting, by the server-side thread management apparatus, the client-side thread management apparatus to generate threads corresponding to the executed threads;
extracting, by the server-side thread management apparatus, one or more of the function related to the graphics task and the function related to the sound task from the executed software;
storing, by the server-side thread management apparatus, the extracted one or more functions; and
detecting, by the server-side thread management apparatus, the stored one or more functions and, by the server-side thread management apparatus, processing the detected one or more functions.

13. The thread management method of claim 12, wherein storing the extracted one or more functions includes storing, by the server-side thread management apparatus, the extracted one or more functions in a synchronous/asynchronous buffer when the extracted function is a void function.

14. The thread management method of claim 12, wherein detecting the stored one or more functions and processing the detected one or more functions includes:
detecting, by the server-side thread management apparatus, functions stored in a synchronous/asynchronous buffer when the synchronous/asynchronous buffer for storing the functions is in a full state; and
sending, by the server-side thread management apparatus, the detected functions to the client-side thread management apparatus.

15. The thread management method of claim 12, wherein detecting the stored one or more functions and processing the detected one or more functions includes sending, by the server-side thread management apparatus, the extracted one or more functions and functions stored in a synchronous/asynchronous buffer to the client-side thread management apparatus when the extracted functions are not void functions.

16. The thread management method of claim 15, wherein detecting the stored one or more functions and processing the detected one or more functions further includes receiving, by the server-side thread management apparatus, results of processing of the transmitted functions from the client-side thread management apparatus.

17. The thread management method of claim 11, wherein receiving the one or more functions and processing the received one or more functions includes:
generating, by the client-side thread management apparatus, a reception-dedicated thread and a function processing thread in response to a thread generation request from the server-side thread management apparatus, and executing, by the client-side thread management apparatus, the reception-dedicated thread and the function processing thread;
receiving, by the client-side thread management apparatus, a function via the reception-dedicated thread, and storing, by the client-side thread management apparatus, the received function in an asynchronous buffer; and
processing, by the client-side thread management apparatus, a function received via the function processing thread.

18. The thread management method of claim 17, wherein processing the function received via the function processing thread includes:
checking, by the client-side thread management apparatus, whether the function received via the function processing thread is a function to be executed next;
storing, by the client-side thread management apparatus, the received function in a synchronous buffer if the function received via the function processing thread is a function to be executed next; and
extracting, by the client-side thread management apparatus, a function to be executed next from the synchronous buffer and the asynchronous buffer.

19. The thread management method of claim 18, wherein processing the function received through the function processing thread further includes processing, by the client-side thread management apparatus, the function determined to be a function to be executed next or the function extracted from the synchronous buffer and the asynchronous buffer.

20. The thread management method of claim 19, wherein processing the function received through the function processing thread further includes sending, by the client-side thread management apparatus, results of the processed function to the server-side thread management apparatus when the processed function is not a void function.
